(19) United States
(12) Patent Application Publication
(10) Pub. No.: US 2006/0071454 A1
(43) Pub. Date: Apr. 6, 2006

(54) Cruise control decorative cover

(76) Inventors: David Gene Young, Emporia, KS (US); Roy Wayne Monroe, Emporia, KS (US)

Correspondence Address: DAVID YOUNG, RT 5, BOX 55Y, EMPORIA, KS, 66801, US

(21) Appl. No.: 10/958,567

(22) Filed: Oct. 5, 2004

(51) Int. Cl. B60N 3/00

(52) U.S. Cl. 280/727

(57) ABSTRACT

The present invention is a decorative cover that is designed to enhance the appearance of a cruise control module, when attached to the vehicle or the cruise control module.

### FIELD OF THE INVENTION

A decorative cover for concealing, hiding or enhancing the appearance of the cruise control module on a vehicle. This cover enhances the final appearance of the cruise control installation.

### BACKGROUNG OF THE INVENTION

Cruise control installed on most vehicles does not have a decorative cover to hide, conceal, or enhance the appearance of the cruise control module. Attention is given to the appearance of the switches that control the operation of the vehicle cruise control, but not to the cruise control module itself. The switches are typically located in the area of the driver, at fingertip reach. These switches are usually blended into the vehicle general appearance so as to compliment the overall appearance of the driver area. The actual unit that controls the speed of the vehicle, the cruise control module, is typically located near the engine. No attention has been given to the appearance of the cruise control module itself. A decorative cover to enhance the appearance of the actual cruise control module is needed.

There does not exist a decorative cover to enhance the appearance of the cruise control module installed on most vehicles.

### SUMMARY OF THE INVENTION

The herein described decorative cover is one part of an installation kit containing multiple parts, to mount and conceal (hide or blend-in) the vehicle manufacturer's electronic “brain”/throttle control. The electronic “brains”/throttle control itself is not part of this invention. This invention is unique in that it uses the electronic “brain”/throttle control already available from the vehicle manufacturer for their other models, but not offered on all models. As an example: Harley Davidson offers cruise control for its' “touring” models only, not for its' other models; Softail, Dyna, Vrod, or Sportster. This invention, the decorative cover is not currently available anywhere.

### BREIF DESCRIPTION OF THE DRAWINGS

FIG. 1 is a general example of the cover, in accordance with an embodiment of the present invention, used to conceal the electronic cruise control module, not to scale. Shape and dimensions will vary depending on brand and model of vehicle, and vehicle manufacturer's vendor supplying the cruise control module.

FIGS. 2 through 9 are detailed examples of the cover showing various views and dimensions of the preferred embodiment. However size and shape will vary depending on the specific application.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms and employed herein, they are used in a generic and descriptive sense only and not for the purpose of limitation.

The following paragraphs describe the decorative cover.

The Cover

In a preferred embodiment the cover will be shaped from a material such as steel, aluminum, plastic, or other material so as to form a “pan-like” shape to surround the cruise control module in such a manor that most of the cruise control is not visible to the casual onlooker.

In a preferred embodiment the cover will conceal the majority of the electronic “brain”/throttle control and wiring harness, but in an alternative embodiment this cover could conceal all or any part of the electronic “brain”/throttle control and/or wiring harness.

In a preferred embodiment the cover will be mounted with bolts, either to the cruise control module itself, or in an alternative embodiment, may be mounted to any part of the vehicle that facilitates making the cruise control not visible to the casual onlooker. In an alternate embodiment any method of mounting the cover may be used instead of bolts.

### BRIEF DESCRIPTION OF THE DRAWINGS

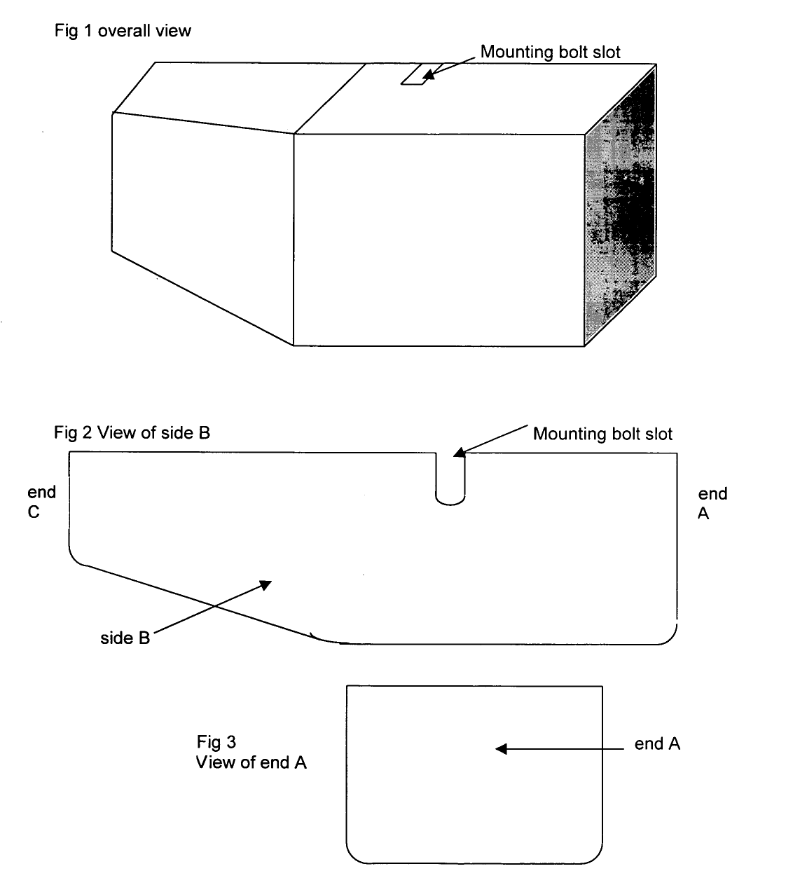

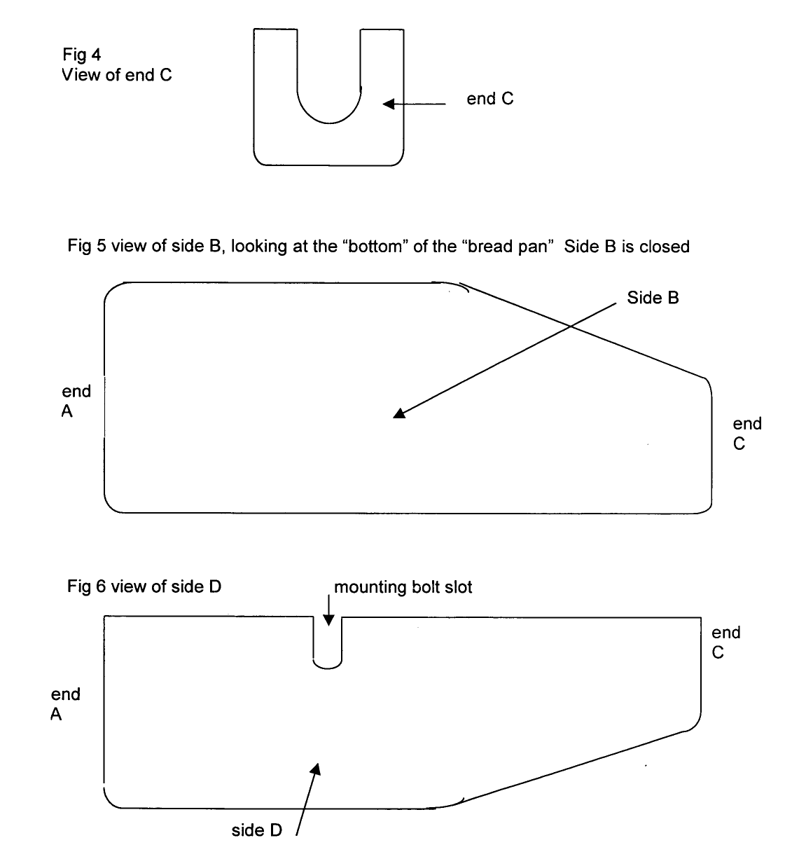

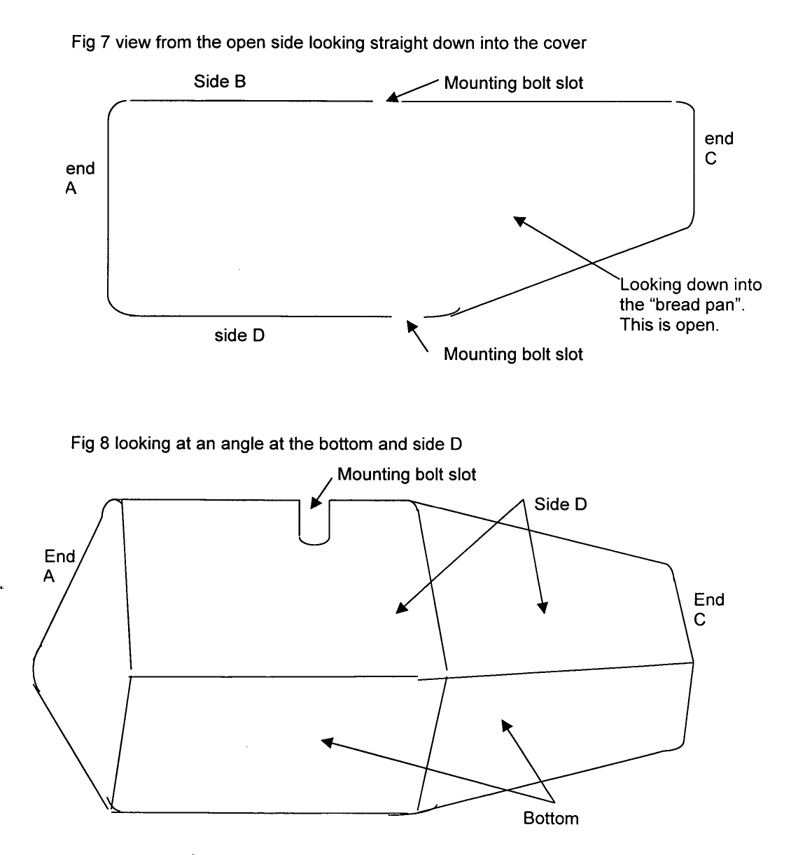

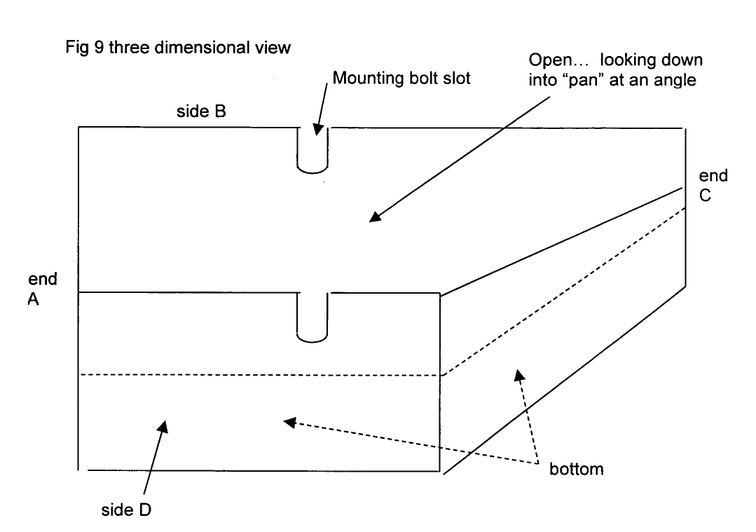

FIG. 1 is an example of a preferred cover to conceal the cruise control module(s), but is only representative of one of many designs that will be readily apparent that may be designed for specific installation requirements, depending of specific vehicle manufacturer, vehicle model or year of manufacturer, or manufacturer's vendor that supplies the cruise control module(s).

That which is claimed:

1. A decorative cover for attaching to the vehicle or cruise control module to conceal any or part of the cruise control module.
